(19) United States
(12) Patent Application Publication
(10) Pub. No.: US 2026/0220252 A1
(43) Pub. Date: Jul. 30, 2026

(54) SYSTEM AND METHOD FOR THE CONFIDENTIAL GENERATION AND ISSUANCE OF SOFTWARE IDENTITIES

(71) Applicant: Dell Products L.P., Round Rock, TX (US)

(72) Inventors: Eugene David Cho, Austin, TX (US); Mukund P. Khatri, Austin, TX (US); Shyam T. Iyer, Cedar Park, TX (US)

(73) Assignee: Dell Products L.P., Round Rock, TX (US)

(21) Appl. No.: 19/040,159

(22) Filed: Jan. 29, 2025

(51) Int. Cl. G06F 21/53; G06F 21/60; G06F 21/64

(52) U.S. Cl. CPC G06F 21/53; G06F 21/604; G06F 21/64

(57) ABSTRACT

Systems and methods for the confidential generation and issuance of software identities are disclosed. According to one embodiment, an Information Handling System (IHS) computer-executable program instructions to in response to a request from a workload, generate, using a Software Identity Service/Agent (VSISA), a Confidential Software Identity (CSWID) for the workload, and bind the CSWID to a Hardware Root-of-Trust (HW-ROT) in the IHS. During the runtime usage of the IHS, the instructions ensure proof of possession for the workload running on the IHS.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Cloud computing refers to a group of network elements providing services on demand, such as data storage and computing power, without directed active management by a user. Cloud computing relies on a sharing of resources to achieve coherence and economies of scale. Cloud computing can be provided as a service over the Internet, such as in the form of "Infrastructure as a Service" (IaaS), "Platform as a Service" (PaaS), and/or "Software as a Service" (SaaS). A Platform as a Service (PaaS) provider allows a consumer to deploy onto the PaaS cloud infrastructure consumer resources created using program language, libraries, services and tools supported by the PaaS provider. The consumer does not manage or control the underlying cloud infrastructure, including the networks, servers, operating systems, or storage, but has control over the deployed applications. Platform as a Service (PaaS) providers offer a computing platform, typically including an operating system, programming language execution environment, database, and web server, and the consumer, or user, develops and runs software on the cloud platform, rather than obtaining and maintaining the underlying hardware and software layers.

### SUMMARY

Systems and methods for the confidential generation and issuance of software identities are disclosed. According to one embodiment, an Information Handling System (IHS) computer-executable program instructions to in response to a request from a workload, generate, using a Software Identity Service/Agent (VSISA), a Confidential Software Identity (CSWID) for the workload, and bind the CSWID to a Hardware Root-of-Trust (HW-ROT) in the IHS. During the runtime usage of the IHS, the instructions ensure proof of possession for the workload running on the IHS.

According to another embodiment, a confidential software identity generation and issuance method includes the steps of, in response to a request from a workload, generating, using a Software Identity Service/Agent (VSISA), a Confidential Software Identity (CSWID) for the workload, binding the CSWID to a Hardware Root-of-Trust (HW-ROT) in the HIS, and allowing a runtime usage of the CSWID by the workload, wherein the runtime usage comprises ensuring proof of possession for the workload running on an Information Handling System (IHS).

According to yet another embodiment, a non-transitory memory storage device has program instructions stored thereon that, upon execution by an Information Handling System (IHS), cause the IHS to, in response to a request from a workload, generate, using a Software Identity Service/Agent (VSISA), a Confidential Software Identity (CSWID) for the workload, bind the CSWID to a Hardware Root-of-Trust (HW-ROT) in the HIS, and allow a runtime usage of the CSWID by the workload, wherein the runtime usage comprises ensuring proof of possession for the workload running on the IHS.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 shows an example of an IHS that may be configured to implement embodiments of the present disclosure.

FIG. 2 illustrates an example confidential software identity generation and issuance system that may provide confidential generation and issuance of software identities according to one embodiment of the present disclosure.

FIG. 3 illustrates an example VSISA landing method that may be used to land (install) a VSISA on a confidential enclave of an IHS according to one embodiment of the present disclosure.

FIG. 4 illustrates an example VSISA registration method that may be used to register the VSISA for use on an IHS according to one embodiment of the present disclosure.

FIG. 5 illustrates an example VSISA workload identity attestation method that may be used to attest the identity of a workload according to one embodiment of the present disclosure.

FIG. 6 illustrates an example VSISA runtime attestation method that may be used to, among other things, establish trust between two workloads on an IHS according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price.

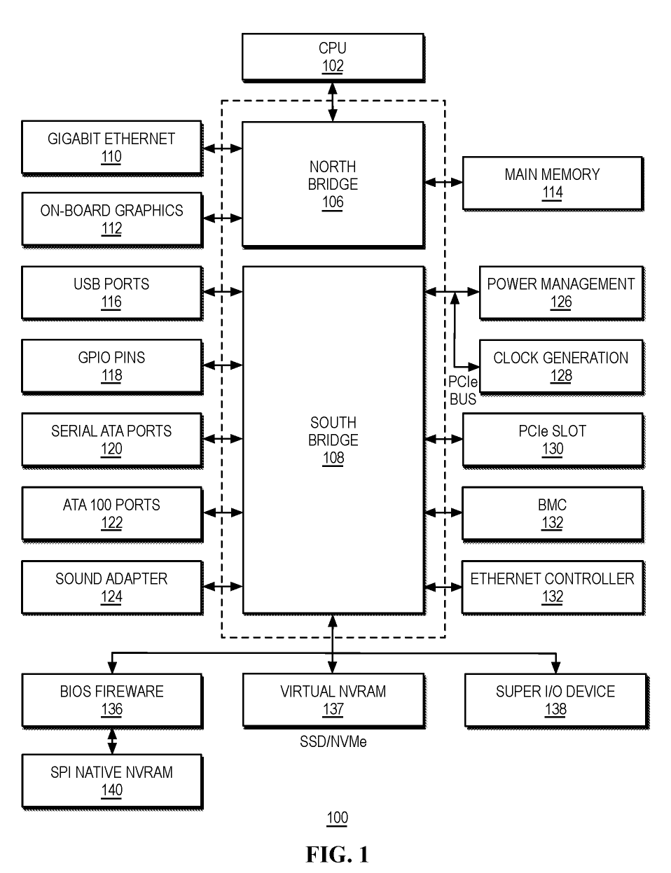

An IHS may include random access memory (RAM), one or more processing resources such as a central processing unit (CPU) or hardware or software control logic, ROM, and/or other types of nonvolatile memory. Additional components of an IHS may include one or more disk drives, one or more network ports for communicating with external devices as well as various input and output (I/O) devices, such as a keyboard, a mouse, touchscreen and/or a video display. An IHS may also include one or more buses operable to transmit communications between the various hardware components. A more detailed example of an IHS is described with respect to FIG. 1. It should be appreciated that although certain embodiments are discussed in the context of a personal computing device, other embodiments may utilize other types of IHSs.

Recently, cloud native workload authentication techniques have been developed to provide a security identity to each of multiple applications (e.g., workloads) running on an IHS. One example of such a workload authentication technique may include a Secure Production Identity Framework for Everyone (SPIFFE) protocol that may run a suitable agent, such as a SPIFFE runtime environment (SPIRE) on the IHS for attesting the workloads. Other workload authentication techniques may exist, such as OS for Crypto SWID, Linux OS (EL0-X) for UID/PID, and an external or local service for assigned unique software (e.g., APEX). These workload authentication techniques may provide a security identity (ID) to each of the workloads and enable an individual application to identify and cryptographically authenticate other applications that it needs to communicate with, such as SPIFFE Verifiable Identity Documents (SVIDs) as used with SPIFFE compliant techniques. Additionally, the SPIFFE SPIRE agent may provide a workload API for any workload (e.g., application) that wants to leverage it.

Nevertheless, such workload Identity Frameworks (e.g., SPIFFE/SPIRE, etc.) usually derive software tokens or identities with no connection to the hardware on which the workload is executed on. They are purposefully done this way in order to maximize mobility and flexibility. Other technologies such as measured boot and DICE aim to derive application identities purely off boot time measurements with Unique-per-device secret, but these technologies provide no connection to build time/update measurements.

An IHS may initially be assigned with an initial device identity (IDEVID) at the factory when it is assembled/manufactured. Once verified, such as by a management entity, The IHS may, per the 802.1AR specification, be assigned with a local device identity (LDEVID), which is better suited for secured channel (i.e. TLS) communication as it supports better certificate/key management practices (e.g., revocation, rotation, etc..) compared to the IDEVID from the manufacturer, due to being long lived.

Regardless of vendor or non-vendor hardware, there are instances where the bare metal OS or hypervisor (e.g., cloud service provider, VM, etc.) can or cannot be controlled and secured by that IHS vendor. Even in the face of these challenges, it would be beneficial to create “unique-per-instance-of-SW running on HW” identities, such as comprehensive software identities (CSWIDs). CSWIDs provide a mechanism for the vendor to assign instances of software to prove/attest it is running on the intended hardware. On the systems noted above, the vendor often does not have a technique to provide “hardware-rooted security services” as the layers of abstraction (e.g., HW, OS, etc.) are controlled by other entities (e.g., Cloud Service Provider (CSP), etc.). In addition to CSWID’s being protected from software exfiltration, it should also support protection across multiple tenants running in the same machine. It should also support workload migration, and the subsequent migration (“reissuance”) of a still valid CSWID, which can be machine to machine, or tenant to tenant. As will be described in detail herein below embodiments of the present disclosure provide a system and method for the confidential generation and issuance of software identities.

FIG. 1 shows an example of an IHS 100 that may be configured to implement embodiments of the present disclosure. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS 100 (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in one embodiment, southbridge 108 may include a serial advanced technology attachment (SATA) adapter for providing one or more serial ATA ports 120 and/or an ATA100 adapter for providing one or more ATA100 ports 122. Serial ATA ports 120 and ATA100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, and the like. Additionally or alternatively, BMC 132 may include one or more firmware volumes, each volume having one or more firmware files used by the BIOS’ firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

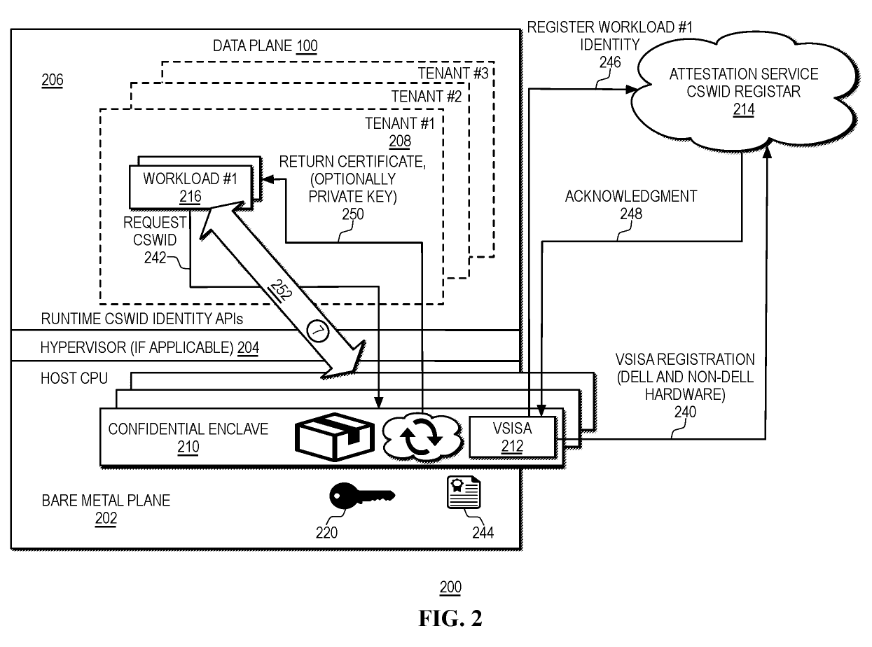

FIG. 2 illustrates an example confidential software identity generation and issuance system 200 that may provide confidential generation and issuance of software identities according to one embodiment of the present disclosure. The confidential software identity generation and issuance system 200 includes an IHS 100 having a bare metal plane 202 running a hypervisor plane 204, which in turn, may run a data plane 206 that supports one or more tenant Virtual Machines (VMs) 208. While the present embodiment is shown with a hypervisor 204, it should be appreciated that in other embodiments, the confidential software identity generation and issuance system 200 may be practiced without any hypervisor 204 in which the data plane 206 is executed directly on the bare metal plane 202.

The bare metal plane 202 includes one or more Trusted Execution Environments (TEEs) or confidential enclaves 210. Many IHSs nowadays are configured with multiple processors (e.g., CPUs, GPUs, smartNICs, DPUs, etc.) that each form their own individual compute domains in which each compute domain usually has a Trusted Execution Environment (TEE) or confidential enclave.

According to embodiments of the present disclosure, the confidential software identity generation and issuance system 200 is configured with a Vendor Software Identity Service/Agent (VSISA) 212 that is stored in a confidential enclave 210, such as a TEE. Initially, when the IHS 100 is started, the VSISA 212 accesses a vendor remote registration service 214 at step 240. Later on, when a workload 216 (application) requests an identity at step 242, the VSISA 212 generates a Confidential Software Identity (CSWID) 220 for the workload 216 at step 244, and registers the CSWID 220 with the vendor remote registration service 214 at step 246. The CSWID 220 is registered with the vendor remote registration service 214 so that it can maintain awareness of what workloads on being used on which IHSs 100. Thereafter at step 248, the vendor remote registration service 214 sends an acknowledgment of the registration of the CSWID 220 to the VSISA 212 at step 248. The VSISA 212 then sends the CSWID 220 to the workload 216 at step 250. In some regards, the workload 216 may use the CSWID 220 to tell it who it is. Thus at runtime, the CSWID 220 may be used to ensure proof of possession for that workload 216 running on that IHS 100 at step 252.

The VSISA 212 may directly (e.g., as a service) or indirectly (e.g., as an agent) issue CSWID 220 to workloads 216 in order to leverage Confidential Compute on-product capabilities and off-product services. At least somewhat similar to a Hardware Root of Trust, the VSISA 212 binds CSWIDS to the hardware, and protects the private key, while allowing its runtime usage by the workload 216. When the VSISA 212 functions as a confidential enclave service, it is directly responsible for the generation and issuance of CSWIDs local to that machine or compute instance (e.g., VM). When the VSISA 212 functions as a confidential enclave Agent, the vendor remote registration service 214 can maintain the coherency of CSWIDs, where the agent will be responsible for hardware binding and unbinding of software identities, thus allowing migration across both machines and tenants (i.e. workload migration).

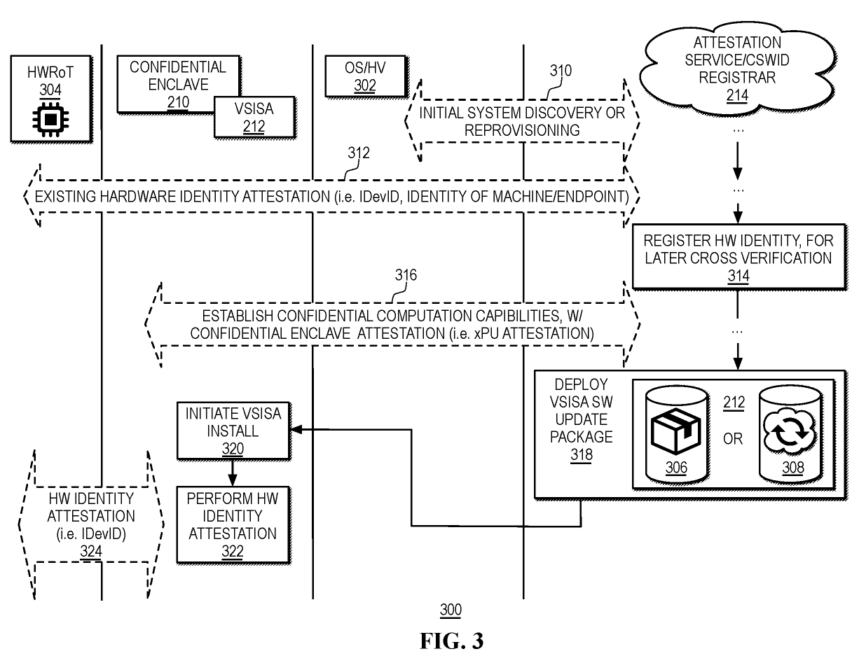

FIG. 3 illustrates an example VSISA landing method 300 that may be used to land (install) a VSISA 212 on a confidential enclave 210 of an IHS 100 according to one embodiment of the present disclosure. Additionally or alternatively, the VSISA landing method 300 may be performed by the confidential software identity generation and issuance system 200 as shown above with reference to FIG. 2.

Initially at step 310, the vendor remote registration service 214 performs an initial system discovery or re-provisioning of the IHS 100, and at step 312, communicates with a Hardware-Root-of-Trust (HW-ROT) 304 to perform attestation of the IHS 100. The HW-RoT 304 may be any suitable type. For example, the HW-RoT 304 may include a confidential enclave configured in the IHS 100. The HW-RoT 304 may be, for example, a TPM configured in the IHS 100. Using the results of the attestation, the vendor remote registration service 214 registers the hardware identity for later cross verification at step 314.

At step 316, the vendor remote registration service 214 establishes confidential computation capabilities with confidential enclave attestation, and at step 318 deploys the VSISA 212 to the confidential enclave 210 within the IHS 100. In one embodiment, the VSISA 212 includes an agent component 306 that assists the software identity service indirectly, and a service component 308 that directly issues software identities to workloads 216. For example, the service component 308 may be used in cases where the IHS 100 is assembled or manufactured by the vendor of the IHS 100, while the agent component 306 may be used in cases where the IHS 100 is assembled or manufactured by an entity other than the vendor of the IHS 100.

At step 320, installation of the VSISA 212 into the confidential enclave 210 is initiated, and at step 322, hardware identity attestation may be performed. In some embodiments, the landed VSISA 212 may communicate with the HW-RoT 304 to perform hardware identity attestation at step 324.

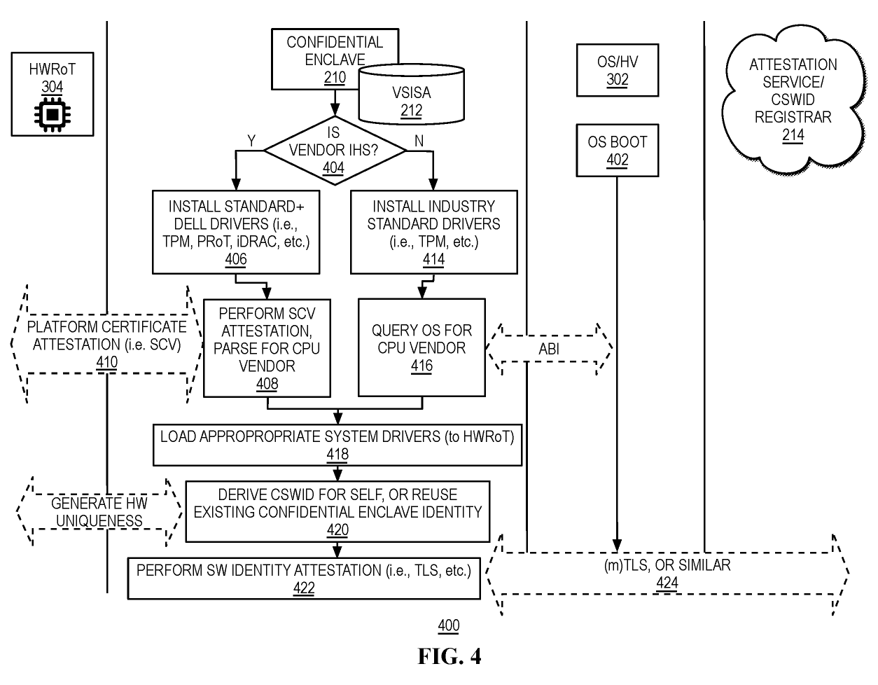

FIG. 4 illustrates an example VSISA registration method 400 that may be used to register the VSISA 212 for use on an IHS 100 according to one embodiment of the present disclosure. Additionally or alternatively, the VSISA registration method 400 may be performed by the confidential software identity generation and issuance system 200 as shown above with reference to FIG. 2. The VSISA registration method 400 may be performed, for example, during a boot process and before the OS is started on the IHS 100.

At step 402, the OS/VM 302 of the IHS 100 commences a boot process on the IHS 100. While the IHS 100 is being booted, the VSISA 212, at step 404, determines whether the IHS 100 is a vendor provided IHS 100. If so, processing continues at step 406; otherwise, processing continues at step 414. In one embodiment, the VSISA registration method 400 may use the IDevID obtained at step 324 to determine whether the IHS 100 is a vendor provided IHS or not. At step 406, the VSISA 212 installs standard vendor drivers, such as that can communicate with a TPM, a ProT device, a BMC 132, and the like. At step 408, the VSISA 212 performs SCV verification and parses information associated with the components.

The VSISA 212 may then communicate with the HW-RoT 304 to perform platform certificate attestation at step 410. SCV generally includes a lightweight service that collects the SCV information and publishes it to a cloud-based verification service, and may be configured to shut down or restrict certain data services provided by the IHS when it determines that the IHS has been tampered with. If the IHS is a vendor provided IHS, the VSISA 212 is able to access the HW-ROT 304 so that SCV attestation may be performed. In general, SCV attestation can be superior in that is functions at the hardware level (“box” level). Moreover, SCV can be superior because the vendor is distinctly aware of at least most of the hardware components in the IHS 100.

If, however, the IHS 100 is not a vendor provided IHS, it continues processing at step 414 in which industry standard drivers (e.g., TPM, etc.) are installed. Thereafter at step 416 in which the VSISA 212 communicates with the OS 302 to identify the vendor of the IHS 100.

At step 418, the VSISA 212 loads appropriate system drivers to be used with the HW-ROT, and at step 420, derives the CSWID 220 for itself (i.e., the VSISA 212). In some cases, the VSISA 212 may use an existing confidential enclave identity. Thereafter at step 422, the VSISA 212 establishes a secure communication channel 424 with the vendor remote registration service 214 and performs software identity attestation.

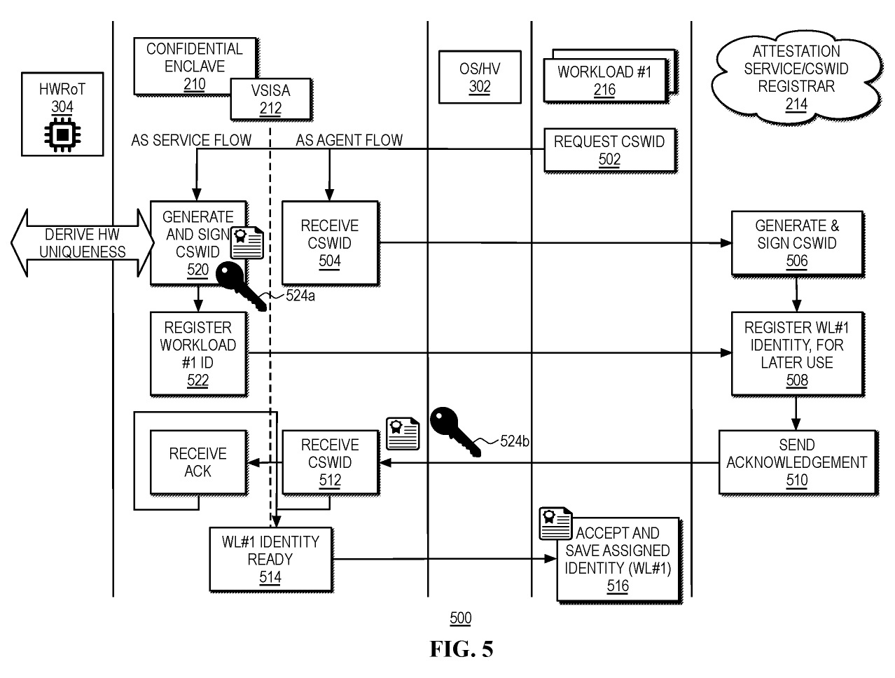

FIG. 5 illustrates an example VSISA workload identity attestation method 500 that may be used to attest the identity of a workload according to one embodiment of the present disclosure. Additionally or alternatively, the VSISA workload identity attestation method 500 may be performed by the confidential software identity generation and issuance system 200 as shown above with reference to FIG. 2.

Initially at step 502 a workload 216 issues a request for a CSWID 220. If the VSISA 212 is functioning as an agent 306, processing will continue at step 504 will be performed. If, however, the VSISA 212 is functioning as a service 308, processing will continue at step 520. In general, if the VSISA 212 is functioning as a service 308, the key 524a associated with the CSWID 220 will be stored locally in the VSISA 212. If, however, the VSISA 212 is functioning as an agent 306, the key 524b associated with the CSWID 220 will be stored remotely in the vendor remote registration service 214.

At step 504, the VSISA 212 forwards the request to the vendor remote registration service 214, which generates and signs the request at step 506, registers the CSWID 220 for use at a later time at step 508, and sends an acknowledgment back to the VSISA 212 at step 510. At step 512, the VSISA 212 receives the CSWID 220, and sends the CSWID 220 to the workload 216 at step 514. The workload 216 then accepts and saves the CSWID 220 at step 516.

At step 520, the VSISA 212, functioning as a service 308, generates and signs the CSWID 220 using the HW-RoT 304 of the IHS 100. Thereafter at step 522, the VSISA 212 registers the workload 216 identity. Thereafter, steps 508-516 are performed in a similar manner as described above.

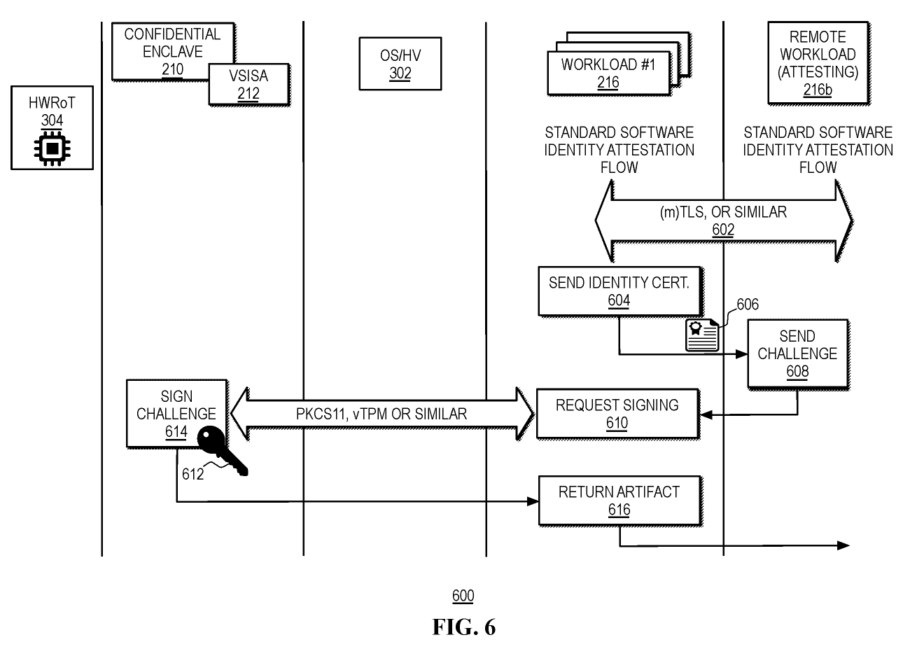

FIG. 6 illustrates an example VSISA runtime attestation method 600 that may be used to, among other things, establish trust between two workloads 216a-b IHS 100 according to one embodiment of the present disclosure. Additionally or alternatively, the VSISA runtime attestation method 600 may be performed by the confidential software identity generation and issuance system 200 as shown above with reference to FIG. 2. The VSISA runtime attestation method 600 may be performed at any suitable time in which the IHS 100 is running.

Initially at step 602, a secure channel is established between the two workloads 216a-b. At step 604, the first workload 216a sends a certificate 606 associated with its CSWID 220 to the second workload 216b. The second workload 216b sends a challenge back to the first workload 216a with the certificate 606 at step 608. The first workload 216a issues a request to the VSISA 212 to request signing at step 610 using a key 612 associated with the CSWID 220. At step 614, the VSISA 212 signs the certificate 606 using the key 612. Thereafter at step 616, the first workload 216a returns the signed certificate for responding to the challenge issued at step 608. At this point, the first workload 216a has established trust with the second workload 216b if/when the certificates match.

Although FIGS. 2 through 6 describe systems and methods for the confidential generation and issuance of software identities, the features of the disclosed systems and methods may be embodied in other specific forms without deviating from the spirit and scope of the present disclosure. For example, the systems and/or methods may perform additional, fewer, or different operations than those described in the present examples. For example, the systems and/or methods may comprise additional, fewer, or different components than those described in the present examples. For another example, the systems and/or methods may be performed in a sequence of steps different from that described above. For yet another example, the systems and/or methods may be performed by components other than what is described herein above.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterward be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS), comprising:
a processor comprising program instructions stored in a memory that, upon execution by the processor, cause the IHS to:
in response to a request from a workload, generate, using a Software Identity Service/Agent (VSISA), a Confidential Software Identity (CSWID) for the workload;
bind the CSWID to a Hardware Root-of-Trust (HW-ROT) in the IHS; and
allow a runtime usage of the CSWID by the workload, wherein the runtime usage comprises ensuring proof of possession for the workload running on the IHS.

2. The IHS of claim 1, wherein the program instructions, upon execution by the host processor, further cause the IHS to execute the VSISA within a Trusted Execution Environment (TEE) configured on the IHS.

3. The IHS of claim 1, wherein the program instructions, upon execution by the host processor, further cause the IHS to execute the VSISA as an agent to query an Operating System (OS) associated with the IHS to attest one or more components configured in the IHS.

4. The IHS of claim 1, wherein the program instructions, upon execution by the host processor, further cause the IHS to execute the VSISA functions as a service to perform Secure Component Verification (SCV) attestation with one or more components configured in the IHS.

5. The IHS of claim 1, wherein the program instructions, upon execution by the host processor, further cause the IHS to use the VSISA to attest a first workload associated with a first VSISA with a second workload associated with a second VSISA.

6. The IHS of claim 1, wherein the workload is deployed in a Virtual Machine (VM) managed by a hypervisor.

7. The IHS of claim 1, wherein the workload is deployed on an Operating System (OS) running on the IHS.

8. The IHS of claim 1, wherein the program instructions, upon execution by the host processor, further cause the IHS to register the CSWID with a remote vendor service.

9. The IHS of claim 1, wherein the program instructions, upon execution by the host processor, further cause the IHS to store a plurality of VSISAs for each of a plurality of tenant VMs configured on the IHS.

10. A confidential software identity generation and issuance method comprising:
in response to a request from a workload, generating, using a Software Identity Service/Agent (VSISA), a Confidential Software Identity (CSWID) for the workload;
binding the CSWID to a Hardware Root-of-Trust (HW-ROT) in the IHS; and
allowing a runtime usage of the CSWID by the workload, wherein the runtime usage comprises ensuring proof of possession for the workload running on an Information Handling System (IHS).

11. The confidential software identity generation and issuance method of claim 10, further comprising executing the VSISA within a Trusted Execution Environment (TEE) configured on the IHS.

12. The confidential software identity generation and issuance method of claim 10, further comprising executing the VSISA as an agent to query an Operating System (OS) associated with the IHS to attest one or more components configured in the IHS.

13. The confidential software identity generation and issuance method of claim 10, further comprising executing the VSISA functions as a service to perform Secure Component Verification (SCV) attestation with one or more components configured in the IHS.

14. The confidential software identity generation and issuance method of claim 10, further comprising using the VSISA to attest a first workload associated with a first VSISA with a second workload associated with a second VSISA.

15. The confidential software identity generation and issuance method of claim 10, further comprising registering the CSWID with a remote vendor service.

16. The confidential software identity generation and issuance method of claim 10, further comprising storing a plurality of VSISAs for each of a plurality of tenant Virtual Machines (VMs) configured on the IHS.

17. A non-transitory memory storage device having program instructions stored thereon that, upon execution by an Information Handling System (IHS), cause the IHS to:
in response to a request from a workload, generate, using a Software Identity Service/Agent (VSISA), a Confidential Software Identity (CSWID) for the workload;
bind the CSWID to a Hardware Root-of-Trust (HW-ROT) in the IHS; and
allow a runtime usage of the CSWID by the workload, wherein the runtime usage comprises ensuring proof of possession for the workload running on the IHS.

18. The non-transitory memory storage device of claim 17, wherein the program instructions, upon execution by the host processor, further cause the IHS to execute the VSISA within a Trusted Execution Environment (TEE) configured on the IHS.

19. The non-transitory memory storage device of claim 17, wherein the program instructions, upon execution by the host processor, further cause the IHS to register the CSWID with a remote vendor service.

20. The non-transitory memory storage device of claim 17, wherein the program instructions, upon execution by the host processor, further cause the IHS to store a plurality of VSISAs for each of a plurality of tenant VMs configured on the IHS.
